(19) United States
(12) Patent Application Publication
(10) Pub. No.: US 2002/0019838 A1
(43) Pub. Date: Feb. 14, 2002

(54) Status identifier for identifying the approval status of an electronic document

(75) Inventor: Tommy Petrogiannis, Montreal (CA)

Correspondence Address: MERCHANT & GOULD PC, P.O. BOX 2903, MINNEAPOLIS, MN, 55402-0903, US

(73) Assignee: Silanis Technology Inc.

(21) Appl. No.: 09/899,731

(22) Filed: Jul. 5, 2001

Related U.S. Application Data
(60) Provisional application No. 60/216,376, filed on Jul. 5, 2000.

(51) Int. Cl. G06F 17/21

(52) U.S. Cl. 707/530

(57) ABSTRACT

In the context of electronic documents approval systems, an electronic document or a section thereof provided with a status identifier. The status identifier, in addition to standard “valid” and “invalid” approval states, has at least one of a “modified and approved” state, indicating that modifications have been made to the document as previously approved by a user but that someone has taken responsibility for these modifications, and an “unknown” state, indicating that it is unknown if the document has been modified since approval by a user.

### FIELD OF THE INVENTION

The present invention relates to the field of systems and methods for the approval of electronic documents, and more particularly concerns a status identifier for use in such systems and methods, for properly identifying the approval status of a given electronic document.

### BACKGROUND OF THE INVENTION

Systems and methods for electronically approving and verifying the authenticity of electronic documents have enjoyed a rising popularity in recent years, with the increased use of electronic versions of documents, as opposed to paper versions, for official business. Descriptions of such systems and methods may for example be found in published international applications nos. WO 00/08541, WO 00/19295 and WO 00119296, all to the present assignee. The result of the use of these systems or methods is an electronic document to which is attached in some manner, an indication that it is the same as approved by at least one user.

For the electronic documents approved through methods and systems according to existing prior art, two possible states exist. They are either valid i.e. this document is the same document that was approved) quite often this is illustrated by a checkmark or some other symbol that indicates validity), or invalid, i.e. that document has been modified since it was last approved (often illustrated by an X or some other symbol that indicates invalidity). However, this binary representation of the “approved” or “modified” state of a document is not adequate for a normal business process. For example, in the paper world, it is not unusual to have a document signed by a user and subsequently modified, the same or another user taking responsibility for the modification by putting his initials next to it. There is currently no available procedure for the modification of approved electronic documents.

### SUMMARY OF THE INVENTION

The present invention therefore provides an electronic document having a status identifier for identifying its approval status. The status identifier has the following possible states:

a first state indicating that at least one section of the electronic document is as approved by an approving user;

a second state indicating that modifications have been made to the at least one section of the electronic document as approved by the approving user; and

a third state indicating that modifications have been made to the at least one section of the electronic document as approved by the approving user but that a modifying user has taken responsibility for these modifications.

Preferably, the electronic document may be provided with a plurality of such status identifiers, each associated with either a different approving user or a different section of the document.

In accordance with another aspect of the present invention, there is provided, in combination with a document approval system for the approval of an electronic document by at least one user, a status identifier for identifying an approval status of at least one section of this electronic document. The status identifier has a first state indicating that the at least one section of the electronic document is as approved by an approving user, a second state indicating that modifications have been made to the at least one section of the electronic document as approved by the approving user, and a third state indicating that modifications have been made to the at least one section of the electronic document as approved by the approving user but that a modifying user has taken responsibility for these modifications.

The present invention further provides, also in combination with a document approval system for the approval of an electronic document by at least one user, a status identifier for identifying an approval status of the electronic document. This status identifier has:

a first state indicating that at least one section of the electronic document is as approved by an approving user;

a second state indicating that modifications have been made to the at least one section of the electronic document as approved by the approving user; and

a third state indicating that it is unknown if the at least one section of the electronic document is as approved by the approving user, the third state of the status identifier being used for storage of the electronic document.

The present invention also provides improvements to a document approval system for the approval of an electronic document by at least one user, the system comprising a status identifier for identifying an approval status of at least one section of the electronic document. The status identifier has a first state indicating that the at least one section of the electronic document is as approved by an approving user and a second state indicating that modifications have been made to the at least one section of the electronic document as approved by the approving user.

In accordance with a first improvement to this system, the status identifier has a third state indicating that modifications have been made to the at least one section of the electronic document as approved by the approving user, but that a modifying user has taken responsibility for said modifications. In the case where the document approval system includes a plurality of status identifiers, each associated with a different approving user, each of these status identifiers is provided with such a third state.

In accordance with a second improvement to the system, the status identifier has a third state indicating that it is unknown if the at least one section of the electronic document is as approved by the approving user.

Further features and advantages of the present invention will be better understood upon reading the following description of preferred embodiments thereof, with reference to the appended drawings.

### BRIEF DESCRIPTION OF THE DRAWINGS

FIG. 1 is a diagram showing an electronic document provided with status identifiers according to a preferred embodiment of the invention.

FIG. 2 (prior art) is a diagram showing the evolution of the status of a document modified after approval by a user in a prior art system.

FIG. 3 is a diagram showing the evolution of the status of a document modified after approval by a user in accordance with a preferred embodiment of the invention.

### DESCRIPTION OF A PREFERRED EMBODIMENT OF THE INVENTION

The present invention provides two new states for an electronic document in the context of systems and methods for the approval of an electronic document.

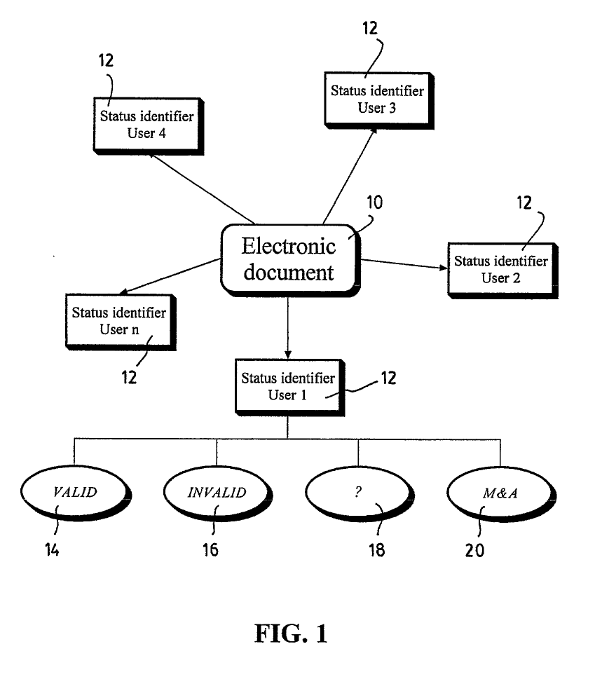

FIG. 1 shows an electronic document 10 to which is attached a plurality of status identifiers 12. Each status identifier is preferably related to approval of the document by a given user. For simplicity, the description below will refer to the approval of an electronic document, but it is understood that the present invention also applies to the case were approval of only one or a limited number of sections of a given electronic document is concerned.

The status identifiers each preferably have four possible states:

a VALID state 14 indicating the electronic document 10 is approved by the related user;

an INVALID state 16 indicating that the document 10 is different from that approved by the user;

an unknown state 18 indicating that it is undetermined if the document 10 is as approved by the user; and

a MODIFIED AND APPROVED (M&A) state 20 indicating that the electronic document 10 has been modified since approved by the related user but that another user (or possibly the same) has taken responsibility for the change.

Modified and Approved State:

This state is advantageous in that it provides visual feedback, making users aware that since a previous approval, someone has altered the document, but then took responsibility for the change. This feature is presently not encompassed by prior art, where in this situation only an invalid state is represented.

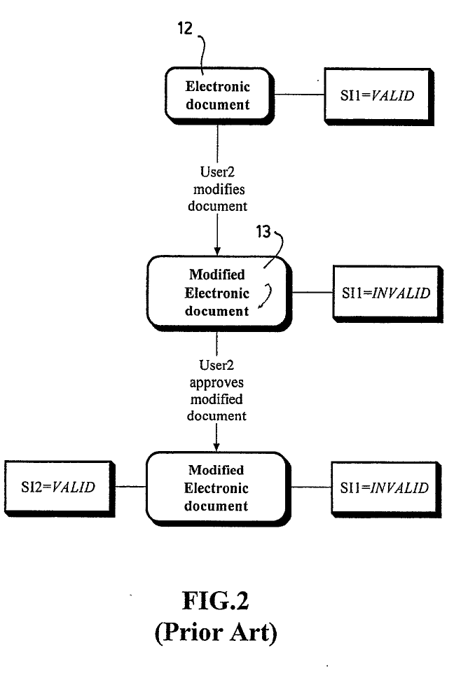

By way of example, FIG. 2 (prior art) shows the states of approval status identifiers for a given document that is modified after a first user has approved it, without the features of the present invention.

First the electronic document 10 is approved by user 1, setting the status identifier associated with this user SI1 to the state “valid”. It will remain so as long as the electronic document stays the same as it was at the moment of approval by user 1.

Let's for example take the case where a user 2 modifies the electronic document after approval by user 1, therefore generating a modified electronic document 13. SI1 is therefore set to the “invalid” state since the document is not the same as approved by user 1.

When user 2 approves the modified document 13, a second status identifier linked to user 2 is set to valid. However, the first status identifier SI1 is still invalid, and there is no way of knowing if user 1 has ever approved the document in the first place.

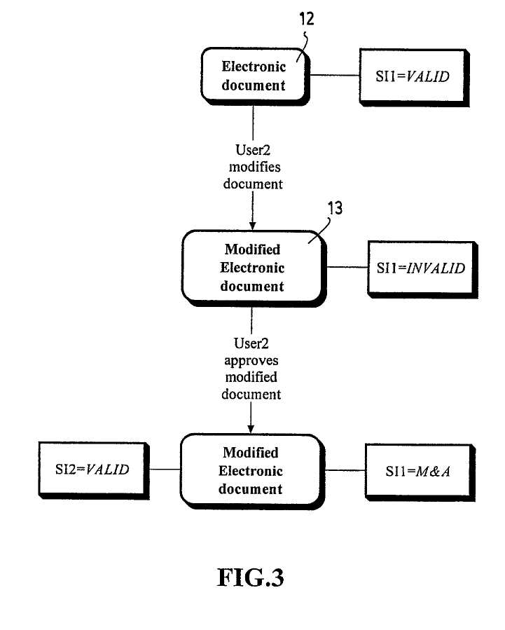

Referring to FIG. 3, the same situation as described above is now repeated in the context of the present invention.

As before, the electronic document 12 is first approved by user 1, setting SI1 to the valid state, and then modified by user 2 to make the modified electronic document 13. SI1 is therefore set to the invalid state.

When user 2 approves the modified document, the second status identifier S12 is set to the valid state as before. However, SI1 is also modified at this point, and is set to the new “modified and approved” state. It now reflects the fact that user 1 has indeed approved the electronic document 12, that it was subsequently modified to generate the current modified electronic document 13, and that someone (in this case user 2) has taken responsibility for the modifications made.

This state is absolutely necessary for standard business practices to move to the electronic domain. Traditionally, in the pen and paper world, when a person signs a document indicating their approval, a second person can freely alter the contents of the document which does not cross out or invalidate the first person's signature. They merely add their signature or initials to accept responsibility for the changes. The reason this works well in the paper world is because changes to a document after the sign off are usually easy to detect by a simple visual inspection (for example, it's easy to see that someone scratched out an amount and wrote a new amount above the original value), therefore detecting an altered state is not a problem.

In the electronic world, visually detecting these changes is difficult, thus the approval display mechanism needs to be able to illustrate the case where a change was made but that someone took responsibility for the change.

This “altered but approved” state can also display more intelligent information such as “the document was altered but Mr. Z took responsibility for the changes”. Obviously these stages can overlap to a fair degree. The following table shows an example of an approval process where 6 people (A-F) are involved;

| Person | | Partial visual of | |
|---|---|---|---|
| Approving | Step | Document State | Explanation |
| A | First person to | Approval #1- | Document is now |
| | approve the | VALID | considered authentic, |
| | document | | in the same state since |
| | | | the person signed it |
| B | Second | Approval #1- | Document is the same |
| | person simply | Valid | document that Person |
| | adds their | Approval #2- | A and B approved. |
| | approval | Valid | |
| | A person | Approval #1- | Document has been |
| | makes a | INVALID | altered since person A |
| | correction or | Approval #2- | and B approved it. |
| | change | INVALID | |
| C | Takes | Approval #1- | Mr. C has taken |
| | responsibility | M & A by Person C | responsibility for the |
| | for the change | Approval #2- | changes |
| | | M & A by Person C | |
| | | Approval #3- | |
| | | VALID | |
| | Another | Approval #1- | Document is not in the |
| | person | INVALID | same state as when the |
| | changes or | Approval #2- | last person approved. |
| | corrects the | INVALID | |
| | document yet | Approval #3- | |
| | again | INVALID | |
| D | Takes | Approval #1- | |
| | responsibility | M & A by Person C | |
| | for the change | Approval #2- | |
| | | M & A by Person C | |
| | | Approval #3- | |
| | | M & A by Person D | |
| | | Approval #4- | |
| | | VALID | |
| E | Agrees with | Approval #1- | |
| | the document | M & A by Person C | |
| | content and | Approval #2- | |
| | approved it. | M & A by Person C | |
| | | Approval #3- | |
| | | M & A by Person D | |
| | | Approval #4- | |
| | | VALID | |
| | | Approval #5- | |
| | | VALID | |
| F | Agrees with | Approval #1- | |
| | the document | M & A by Person C | |
| | content and | Approval #2- | |
| | approved it. | M & A by Person C | |
| | | Approval #3- | |
| | | M & A by Person D | |
| | | Approval #4- | |
| | | VALID | |
| | | Approval #5- | |
| | | VALID | |
| | | Approval #6- | |
| | | VALID | |

Unknown State

This state is particularly useful in cases where the software required to perform the validation of the document's integrity is not available or in the case where the software function to perform the integrity checking has not been invoked. This state is also referred to as a safe mode. This state can be represented by a question mark (?) or some other symbol that indicates an undetermined state. This is the ideal state to use when closing or storing a document into an archival situation—the reason being that an end user who has access to the document but not to the software to check the validity of the document, will only be able to access the document and not be able to incorrectly assume that the document is valid or not—it is undetermined until the verification software is run.

The present invention therefore provides an electronic document provided with a status identifier, having either one or both of the two new states described above. The electronic document may be combined to any appropriate document approval system. It may be advantageous to improve an existing document approval system by having it assign, to approved documents, a status identifier having those possible states. It is understood that an electronic document according to the present invention, may be provided with a plurality of status identifiers as described above, each associated with a different user, but that a single one of such status identifiers is sufficient for the scope of the present invention.

Although the present invention has been explained hereinabove by way of a preferred embodiment thereof, it should be pointed out that any modifications to this preferred embodiment within the scope of the appended claims is not deemed to alter or change the nature and scope of the present invention.

What is claimed is:

1. An electronic document provided with a status identifier for identifying an approval status of at least one section of said electronic document, said status identifier having a first state indicating that the at least one section of the electronic document is as approved by an approving user, a second state indicating that modifications have been made to the at least one section of the electronic document as approved by said approving user, and a third state indicating that modifications have been made to the at least one section of the electronic document as approved by the approving user, but that a modifying user has taken responsibility for said modifications.

2. An electronic document according to claim 1, wherein said status identifier has a fourth state indicating that it is unknown if the at least one section of the electronic document is as approved by the approving user.

3. An electronic document according to claim 1, wherein, in said third state of the status identifier, the modifying user is different from the approving user.

4. An electronic document according to claim 1, wherein, in said third state of the status identifier, the modifying user is the same as the approving user.

5. An electronic document according to claim 1, wherein the third state of the status identifier further indicates an identity of said modifying user.

6. An electronic document according to claim 1, wherein said status identifier is integrated to said electronic document.

7. An electronic document according to claim 1, wherein said at least one section of the electronic document includes the entire electronic document.

8. An electronic document provided with a plurality of status identifiers as claimed in claim 1, each of said status identifiers being associated with a different section of said electronic document.

9. An electronic document provided with a plurality of status identifiers as claimed in claim 1, each of said status identifiers being associated with a different approving user.

10. In combination with a document approval system for the approval of an electronic document by at least one user, a status identifier for identifying an approval status of at least one section of said electronic document, said status identifier having a first state indicating that the at least one section of the electronic document is as approved by an approving user, a second state indicating that modifications have been made to the at least one section of the electronic document as approved by said approving user, and a third state indicating that modifications have been made to the at least one section of the electronic document as approved by the approving user but that a modifying user has taken responsibility for said modifications.

11. A combination according to claim 10, wherein, in said third state of the status identifier, the modifying is different from the approving user.

12. A combination according to claim 10, wherein, in said third state of the status identifier, the modifying is the same as the approving user.

13. A combination according to claim 10, wherein said status identifier is integrated to said electronic document.

14. A combination according to claim 10, wherein said status identifier has a fourth state indicating that it is unknown if the at least one section of the electronic document is as approved by the approving user.

15. A combination according to claim 10, wherein said at least one section of the electronic document includes the entire electronic document.

16. In combination with a document approval system for the approval of an electronic document by at least one user, a status identifier for identifying an approval status of at least one section of said electronic document, said status identifier having a first state indicating that the at least one section of the electronic document is as approved by an approving user, a second state indicating that modifications have been made to the at least one section of the electronic document as approved by said approving user, and a third state indicating that it is unknown if the at least one section of the electronic document is as approved by the approving user, said third state of the status identifier being used for storage of the electronic document.

17. In a document approval system for the approval of an electronic document by at least one user, said system comprising a status identifier for identifying an approval status of at least one section of said electronic document, said status identifier having a first state indicating that the at least one section of the electronic document is as approved by an approving user and a second state indicating that modifications have been made to the at least one section of the electronic document as approved by the approving user, the improvement wherein said status identifier has a third state indicating that modifications have been made to the at least one section of the electronic document as approved by the approving user but that a modifying user has taken responsibility for said modifications.

18. An improved document approval system according to claim 17 wherein, in said third state of the status identifier, the modifying user is different from the approving user.

19. An improved document approval system according to claim 17, wherein, in said third state of the status identifier, the modifying user is the same as the approving user.

20. An improved document approval system according to claim 17, wherein said status identifier is integrated to said electronic document.

21. An improved document approval system according to claim 17, wherein said status identifier has a fourth state indicating that it is unknown if the at least one section of the electronic document is as approved by the approving user.

22. An improved document approval system according to claim 17, wherein said at least one section of the electronic document includes the entire electronic document.

23. In a document approval system for the approval of an electronic document, said system comprising a plurality of status identifiers for identifying an approval status of at least one section of said electronic document by a plurality of identifying users, each of said status identifiers having a first state indicating that the at least one section of the electronic document is as approved by an approving user and a second state indicating that modifications have been made to the at least one section of the electronic document as approved by the approving user, the improvement wherein each of said status identifiers has a third state indicating that modifications have been made to the at least one section of the electronic document as approved by the approving user but that a modifying user has taken responsibility for said modifications.

24. In a document approval system for the approval of an electronic document by at least one user, said system comprising a status identifier for identifying an approval status of at least one section of said electronic document, said status identifier having a first state indicating that the at least one section of the electronic document is as approved by an approving user and a second state indicating that modifications have been made to the at least one section of the electronic document as approved by said approving user, the improvement wherein said status identifier has a third state indicating that it is unknown if the at least one section of the electronic document is as approved by the approving user.
